(19) United States
(12) Patent Application Publication
(10) Pub. No.: US 2008/0187151 A1
(43) Pub. Date: Aug. 7, 2008

(54) Earphone cushion

(76) Inventor: Dephillia J. McClenon, Fresno, TX (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/701,495

(22) Filed: Feb. 2, 2007

(51) Int. Cl. H04R 1/10

(52) U.S. Cl. 381/74

(57) ABSTRACT

An earphone cushion for a communications headset. The cushion includes a resilient pad affixed within a bag. The pad includes a foam disk for engagement with a headset earphone. The periphery of the cover is gathered by means of an elastic band for grasping the earphone.

### FIELD OF THE INVENTION

The present invention relates generally to acoustics and, more particularly, to acoustic devices with an anatomic or prosthetic relation.

### BACKGROUND OF THE INVENTION

Headsets are commonly used in telephone call centers and restaurants with drive-thru windows for salespeople to converse with customers. For the comfort of wearers, headset earphones are typically enclosed in a cushion of open-celled foam. Over time, these cushions become contaminated with a mixture of dirt, bodily fluids, food, and other foreign matter. Thus, earphone cushions can serve as a breading ground for germs and as a pathway for the transmission of disease from one salesperson to another if headsets are shared.

It has long been known that, by placing impermeable covers, resembling mini shower caps, over the earphone cushions of communications headsets, the cushions can be maintained in a sanitary condition. Such a condition serves to foster goodwill with salespeople and other personnel required to wear headsets and to minimize the likelihood of an illness being transmitted. So, with a minimal investment in earphone cushion covers, personnel attrition and absences from work can be reduced.

Headphone cushions are frequently lost or damaged. It is not unusual for a cushion to become lodged in a disposable cover at the time of the cover's replacement and inadvertently thrown away. Additionally, some cushions are damaged when cleaned with inappropriate solvents. In either case, replacing a lost or damaged cushion that is a part of a communications headset can be a time-consuming and costly undertaking.

### SUMMARY OF THE INVENTION

In light of the problems associated with the known communications headsets, it is a principal object of the invention to provide a disposable product that combines an earphone cushion with a cover that prevents foreign matter from contacting a headset earphone. This earphone cushion will foster goodwill on the part of sales personnel and others required to wear communications headsets so equipped and minimize the spread of germs to said personnel. Also, passersby will be impressed by the attention to the welfare of the employees afforded by the business that employs the new, earphone cushions.

It is another object of the invention to provide an earphone cushion of the type described that can be deployed and used with minimal instruction and without resort to tools.

It is a further object of the invention to provide an cushion of the type described that provides spaced-apart, primary and secondary seals against an earphone to prevent the penetration of foreign matter.

It is an object of the invention to provide improved features and arrangements thereof in an earphone cushion for the purposes described that is lightweight in construction, inexpensive to manufacture, and dependable in use.

Briefly, the cushion in accordance with this invention achieves the intended objects by featuring a protective bag including a disk of flexible sheeting and an elastic band affixed to the periphery of the disk. A resilient pad is positioned within the protective bag. The pad has a circular base member that is affixed to the disk and an optional, retaining band that is affixed to the base member. The retaining band includes a peripheral flange projecting forwardly from the outer edge of the base member and a peripheral lip projecting inwardly from the front of the peripheral flange. The lip has an edge defining an orifice in the front of the pad into which an earphone can be inserted. A peripheral groove, for receiving the retaining ring of the earphone, is located between the base member and the lip and is accessible through the orifice.

The foregoing and other objects, features, and advantages of my earphone cushion will become readily apparent upon further review of the following detailed description of the preferred cushion embodiments as illustrated in the accompanying drawings.

### BRIEF DESCRIPTION OF THE DRAWINGS

My earphone cushion can be more readily described with reference to the accompanying drawings, in which:

FIG. 1 is a perspective view of a cushion in accordance with the present invention positioned on the earphone of a communications headset with portions of the headset being broken away for the sake of drawing convenience.

FIG. 2 is a side view of the cushion of FIG. 1 being mounted upon the earphone of a communications headset.

FIG. 3 is a cross-sectional view of the cushion of FIG. 1 mounted upon the earphone of a communications headset.

FIG. 4 is a perspective view of the earphone cushion of FIG. 1 with the protective bag portion thereof being fully opened to reveal the resilient pad portion thereof.

FIG. 5 is a perspective view of an alternative resilient pad for use in the earphone cushion.

FIG. 6 is a perspective view of a further alternative pad for use in the earphone cushion.

FIG. 7 is a cross-sectional view of a cushion, having the pad of FIG. 6, mounted upon the earphone of a communications headset.

Similar reference characters denote corresponding features consistently throughout the accompanying drawings.

### DETAILED DESCRIPTION OF THE PREFERRED EMBODIMENTS

Referring now to the FIGS., an earphone cushion in accordance with the present invention is shown at 10. Cushion 10 includes a protective bag 12 within which is affixed a resilient pad 14 adapted for releasable engagement with the earphone 16 of a communications headset 18. In use, pad 14 makes headset 18 comfortable to wear, blocks noise from passing into the ear of a wearer, and prevents foreign matter from entering the usual openings provided in the front of earphone. Bag 12, however, maintains pad 14 and earphone 16 in a clean and sanitary condition.

Protective bag 12 comprises a disk 20 of flexible sheeting such as spunbond, nonwoven polypropylene having a diameter A measuring about 4 inches (10.2 cm) and being 0.008 inches (0.20 mm) in thickness. Made of continuous filaments, spunbonds are inherently high in strength and resistant to tearing. Furthermore, while spunbonds are air permeable, sound transparent, and moisture absorbent, their small pores are substantially impervious to the passage of dirt, dust, and grime. Of course, many other materials, papers, and fabrics possess characteristics similar to those of spunbonds and can be employed with equal facility in forming disk 20.

An elastic band 22 is affixed to the periphery of disk 20. One elegant way of forming band 22 involves the sewing of a seam of chain stitches using elastomeric thread about the outer edge of disk 20 as shown in the FIGS. The seam is easy to apply with a sewing machine and reinforces the periphery of disk 20 in the manner of a hem, minimizing fraying. If desired, band 22 can be formed away from disk 20 and subsequently attached to it by heat sealing, gluing, or other suitable method. Once attached, band 22 gathers the periphery of disk 20 into a circle having a diameter of about 1 inch (2.54 cm) that defines the principal opening 24 into bag 12.

Resilient pad 14 comprises a circular base member 26, formed of foam, with a diameter B of about 2 inches (5.1 cm) and thickness of about 0.125 inches (3.2 mm). Integrally fastened to base member 26 is a foam retaining band 28. Band 28 includes a peripheral flange 30, measuring about 0.125 inches (3.2 mm) in thickness and 0.5 inches (1.3 cm) in width, that projects forwardly from the outer edge of base member 26 and a peripheral lip 32, measuring about 0.125 inches (3.2 mm) in thickness, that projects inwardly from the front of flange 30 parallel to base member 26. The free edge 34 of lip 32 defines a circular opening in the front of pad 14 about 1.5 inches (3.8 cm) in diameter into which earphone 16 can be inserted. Between base member 26 and lip 32, a peripheral groove 36 is formed within pad 14 for snugly receiving a retaining ring 38 on the exterior of earphone 16. Overall, pad 14 has an outer diameter of about 2 inches (5.1 cm) and a thickness or width of about 0.5 inches (1.3 cm).

Pad 14 is formed from open-celled, polyurethane foam which is permeable to air thereby making cushion 10 breathable and suitable for wear for prolonged periods. Pad 14, however, could be formed, for example, from another polyurethane-based material commonly referred to as “memory” foam or visco-elastic foam. Memory foam is denser than open-celled foam but has a remarkable resiliency. It will conform closely to the contours of irregularly shaped objects pressed into it, yet will spring back to its original form when the objects are removed, hence it seats comfortably against a user's ear and seals out background noise. Memory foam is, unfortunately, substantially impermeable to air, so it better suited for periods of short-term use.

Pad 14 is affixed within bag 12 by an adhesive film 40 arranged as a ring with a diameter of about 1 inch (2.5 cm) between the front of base member 26 and the inner surface of bag 12 so as to not impede sound transmissions from earphone 16. Adhesive film 40 can be formed from any suitable adhesive known in the art. Alternatively, pad 14 can be affixed within bag 14 by means of sewn seams, hook-and-loop fasteners, snaps, and like mechanical fasteners. Since retaining band 28 is free of adhesive film 40, i.e., bag 12 is “oversized” relative to pad 14 so that pad 14 rests loosely within bag 12, elastic band 22 can be slid away from retaining band 28 for the unencumbered insertion of earphone 16 into pad 14.

After affixing pad 14 within bag 12, cushion 10 can be treated to minimize the spread of germs. For example, at the time of manufacture, cushion 10 can be sterilized and sealed in a conventional manner to ensure that sanitary conditions exist when a user first receives cushion 10. Furthermore, cushion 10 can be sprayed or otherwise provided with a coating of an anti-microbial agent capable of inhibiting the growth of germs that may contact cushion 10 while it is being used in the field. Water repellant coatings can also be applied to cushion 10 to keep earphone 16 dry.

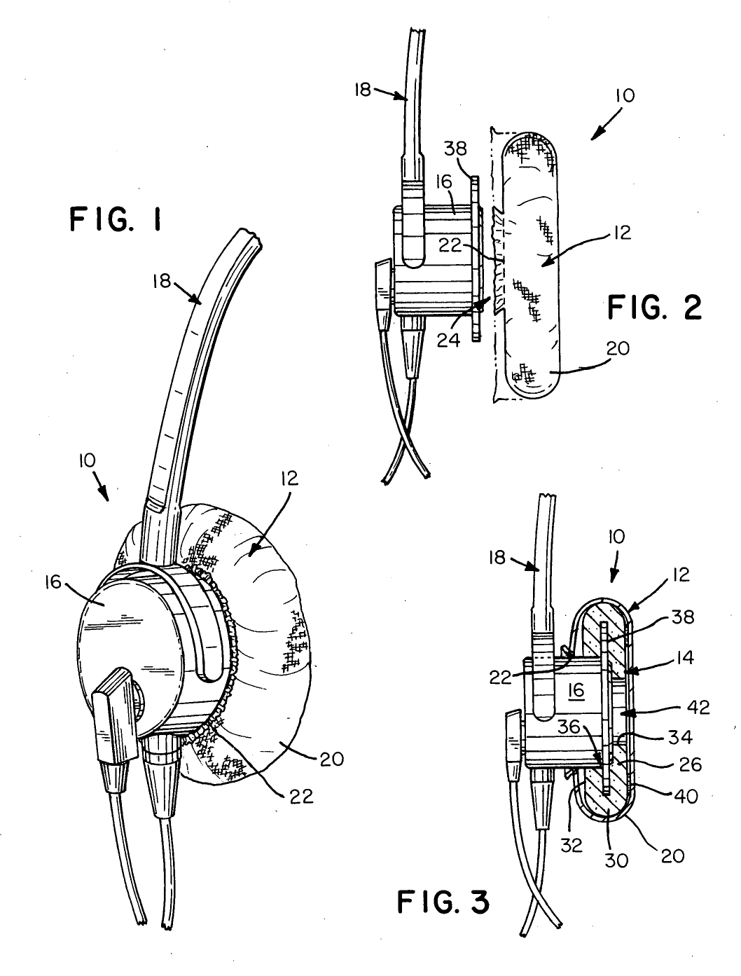

The use of earphone cushion 10 is straightforward. First, assuming that earphone 16 is exposed as illustrated in FIG. 2, the bottom of retaining ring 38 is inserted into the bottom of groove 36 in pad 14. Then, working perhaps in a clockwise manner, retaining band 28 is incrementally stretched over ring 38 so as to position ring 38 fully into groove 36. Now, with pad 14 secured to earphone 16, elastic band 22 of bag 12 is pulled forwardly, off retaining band 28, and into engagement with earphone 16 forwardly of retaining ring 38. Finally, with cushion 10 being secured to earphone 16, headset 18 is donned with electronic communications being conducted in the usual manner. With the diameter of earphone 16 being somewhat greater than the diameters of principal opening 24 of bag 12 and free edge 34 of lip 32, cushion 10 is retained snugly upon earphone 16 with little likelihood that dirt, grime, and germs present upon the ear of a wearer will contaminate earphone 16.

With bag 12 being positioned against the ear of a wearer to absorb perspiration and wayward dirt, pad 14 provides comfort and reduces the noise entering the ear. After use, the soiled cushion 10 is removed from earphone 16 by reversing the order of the steps outlined above. The used cushion 10 is discarded, if desired, or reused later by the same wearer. The entire process for installing and removing cushions 10 upon earphone 16 requires just a few seconds to complete. Thus, merely by swapping earphone cushions 10, headset 18 can be easily passed from one wearer to another in a completely sanitary manner. The entire process of replacing a soiled cushion 10, requires just a few seconds to complete.

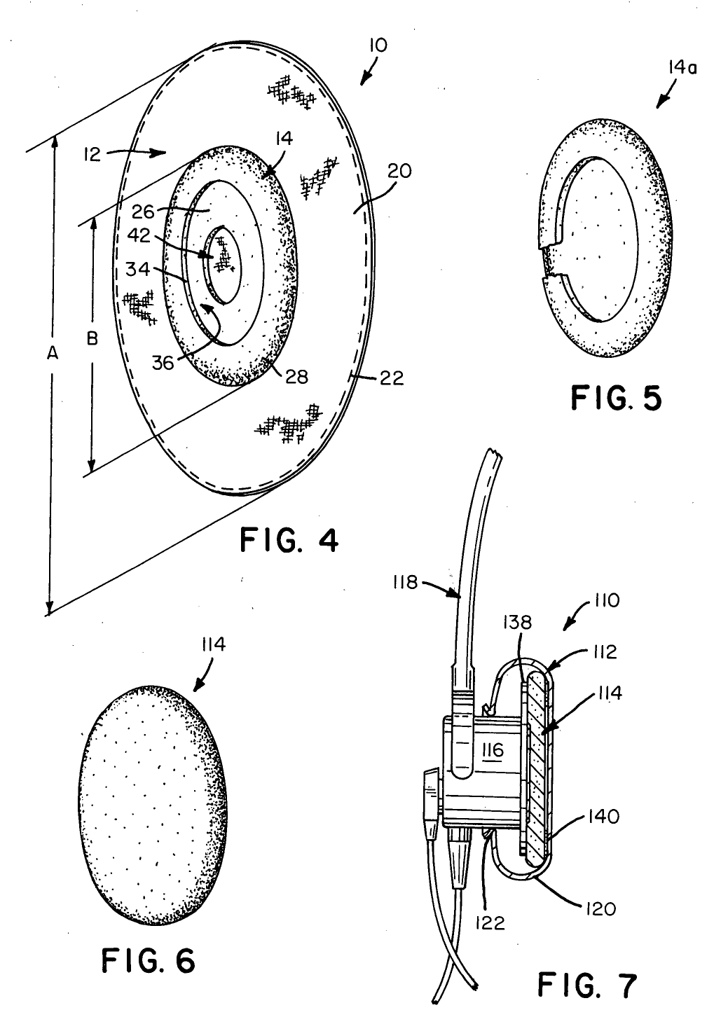

While earphone cushion 10 has been described with a high degree of particularity, it will be appreciated by those skilled in the art that modifications can be made to it. For example, as shown in FIGS. 3 and 4, a central opening 42 is preferably provided in base member 26 of pad 14 for improved sound transmission through cover 10. Opening 42 has a diameter of about 1 inch (2.5 cm) and helps channel sounds emanated from earphone 16 ear of the wearer. Nevertheless, as illustrated in FIG. 5, a resilient pad 14a, being identical in all respects to pad 14 except for the absence of opening 42, can be readily substituted for pad 14 within cushion 10. Pad 14a, however, may fractionally reduce the sound transmissive capabilities of cushion 10 but could be somewhat more comfortable to wear.

As illustrated in FIGS. 6 and 7, a cushion 110 can be produced with a foam pad 114 that lacks a retaining band 28. Cushion 110 includes a protective bag 112 within which is affixed a resilient pad 114 for abutment against the earphone 116 of a communications headset 118. Bag 112 comprises a disk 120 of flexible sheeting, to the periphery of which an elastic band 122 is affixed for gathering the periphery of disk 120 into a circle of small diameter defining the principal opening into bag 112. Pad 114 is a disk formed from a suitable foam having a diameter greater than retaining ring 138 of earphone 116. Pad 114 is affixed within bag 112 by a ring of adhesive 140 positioned between the front of pad 114 and the inner surface of bag 112. Bag 112 is “oversized” relative to pad 114 so that pad 114 rests loosely within bag 112 and elastic band 22 can be slid well away from pad 114 to cover the majority of earphone 116 in an unencumbered manner.

Therefore, it is to be understood that the present invention is not limited to the earphone cushions described above, but encompasses any and all earphone cushion embodiments within the scope of the following claims.

I claim:

1. A cushion for use with a headset having an earphone with a retaining ring, said cushion comprising:
a protective bag including:
a disk of flexible sheeting having a periphery; and,
an elastic band being affixed to the periphery of said disk for gathering the periphery of said disk into a small circle defining the principal opening into said bag into which the earphone can be selectively inserted and withdrawn; and,
a resilient pad being positioned within said protective bag and being adapted for releasable engagement with the earphone, said pad including:
a circular base member being affixed to said disk and having an outer edge;
a retaining band being affixed to said base member, said retaining band including:
a peripheral flange projecting forwardly from said outer edge of said base member; and,
a peripheral lip projecting inwardly from the front of said peripheral flange, said lip having an edge defining an orifice in the front of said pad into which the earphone can be selectively inserted and withdrawn; and,
a peripheral groove being located between said base member and said lip and being accessible through said orifice, and said peripheral groove being adapted to snugly receive the retaining ring of the earphone.

2. The earphone cushion according to claim 1 wherein said disk is formed of spunbond, nonwoven polypropylene.

3. The earphone cushion according to claim 1 wherein said elastic band is a chain stitched seam of elastomeric thread.

4. The earphone cushion according to claim 1 wherein said disk has a diameter about twice as large as that of said pad.

5. The earphone cushion according to claim 1 further comprising an adhesive film being located between said disk and said base member for affixing said pad within said bag.

6. A cushion for use with a headset having an earphone with a retaining ring, said cushion comprising:
a protective bag including:
a disk of spunbond, nonwoven polypropylene; and,
an elastic band being affixed to the periphery of said disk for gathering the periphery of said disk into a small circle defining the principal opening into said bag into which the earphone can be selectively inserted and subsequently withdrawn; and,
a resilient pad being positioned within said protective bag and being adapted for abutment with the earphone.
